(19) United States
(12) Patent Application Publication
(10) Pub. No.: US 2011/0258087 A1
(43) Pub. Date: Oct. 20, 2011

(54) ANALYTICS FOR SETTING UP STRATEGIC INVENTORY SYSTEMS TO HANDLE SMALL LOT ORDERS IN THE STEEL INDUSTRY

(75) Inventors: Soumyadip Ghosh, Peekskill, NY (US); Jayant R. Kalagnanam, Briarcliff Manor, NY (US)

(73) Assignee: INTERNATIONAL BUSINESS MACHINES CORPORATION, Armonk, NY (US)

(21) Appl. No.: 12/760,101

(22) Filed: Apr. 14, 2010

(51) Int. Cl. G06Q 10/00; G05B 13/04; G05B 13/02

(52) U.S. Cl. 705/29; 700/101; 700/106; 705/7.25

(57) ABSTRACT

A method of managing manufacturing production includes determining a plurality of products for manufacture using a production line is disclosed. Each product is specified by composition and production line steps and criteria. Production orders for products are analyzed to determine whether products should be grouped into product-types, and whether product (type) should be made-to-stock or made to order. Queuing theory based analytic methods and optimization based heuristics are used to determine the priority for each product in the production line, taking product substitution opportunities in batch-production into account. Preselected points along the production line are determined for gathering an amount of inventory for each product. This decision is made considering product-differentiation down the line. An established inventory policy for each product at preselected points along the production line requires that inventory is reviewed and an order is placed for additional inventory when on hand inventory reaches a predetermined reorder point.

### FIELD OF THE INVENTION

The present invention relates to a method of managing manufacturing production and, more specifically, relates to a method of managing manufacturing production of a plurality of products including prioritizing, and calculating amounts and locations of inventory in the process.

### BACKGROUND OF THE INVENTION

Manufacturing products include complex production systems and processes including, for example, inventory systems and production models. In an exemplary embodiment of manufacturing, steel manufacturing is a particularly complex production process, with multiple production stages, mixture of order types, and various manufacturing and capacity constraints. The major raw materials used in steel manufacturing processes include iron ore lumps, sinters and pellets, coke (made from coking coal) and fluxes such as limestone, dolomite. These raw materials go through several basic processing steps, including Melting, Refining, Casting, Rolling etc., to produce steel in semi-finished forms such as slabs, rolls, billets etc. Customers can purchase steel in this semi-finished form and process them further to transform into final products or require that the steel manufacturer perform this secondary processing in-house (typically in an auxiliary workshop).

More specifically, the processing step terms are defined as below.

Melting: Raw materials are charged in a blast furnace where hot air is pumped to melt iron and fluxes at 1600 C. The molten metal when cooled and solidified is called pig iron. Alternatively, it can be further refined to make steel. Slag (fluxes with foreign matter from ore) is separated, and blended with clinker to make cement.

Refining: Molten metal from the blast furnace is taken to steel melting shop where further reduction of impurities is done in oxygen furnace (LD converter) or open health furnace which is old technology. The crude steel in liquid form is taken in a ladle for further refining/addition of Ferro alloys etc.

Casting: The liquid steel is cast into semi finished products such as billets, blooms, slabs etc. This process called continuous casting is different from old technology (still in use in older plants) where liquid steel is first solidified in large blocks called ingots and then rolled into semis, involving higher energy and waste in re-heating.

Rolling: The semis such as billets, blooms, slabs are heated at 1200 C to make metal malleable and then rolled into finished products. There are different rolling mills for different products. Rolling mill for long products such as bars, angles, structural etc. can be part of steel making plant or an independent small-scale industry. Flat product rolling mills are capital intensive, as they have to meet strict quality parameters. Rolling rolls slabs in flat product HR plate/strip/coil by process of heating the slab followed. HR sheets thickness can be further reduced by cold rolling i.e., rolling in CR mill at room temperature. CR can be zinc coated in a galvanizing plant to make galvanized plates or corrugated sheets. (GP/GC). Wire rods can be drawn to make wires.

Currently most of the productions are made in a prioritized make-to-order fashion. Orders that require different weights, sizes, and steel grades are given different priorities. Charging and casting stages have limited capacity. To improve on-time delivery, a natural proposal is to stock inventory for some products. Two types of inventories would emerge in this situation: planned inventory and unplanned inventory. Planned inventory is the cycle stock and safety stock that are used to hedge against random demand, and unplanned inventory is the steel wastage due to the fact that a full charge or cast has to be processed independent of the smaller order size. One inventory management problem is where orders of a mixture of different weight, width, steel quality, and due date requirements, are to be produced in a mixture of make-to-order and make-to-stock processes.

A typical ore-to-steel manufacturing plant does production runs in response to orders placed by its customers. Orders are produced in sizes that are multiples of a certain minimum because the main stages of semi-finished steel manufacturing involve chemical and metallurgical processes that are economical only when performed over large batches. For instance, charging and casting stages require significant runtimes for each run, and hence the tools should be as fully utilized as possible.

Steel production runs are typically Made-to-Order, that is, triggered by actual orders received. Order processing is prioritized based on important requirements (due-date, revenue generated etc.) on each order. Orders sizes vary, and the steel ordered differs in physical characteristics (thickness and width) and in its chemical composition (also called grade). The order book of a steel plant is typically filled with bulk orders from a few steady customers, for instance from automobile manufacturers. Thus large-size production constraints have historically been in line with the sales imperatives of the steel manufacturing plant.

However, manufacturers increasingly face competition from scrap metal re-processors for such large orders, adversely affecting their revenue margin, which has resulted in erosion in the number of such large orders. However, scrap metal reprocessing is limited in the quality of steel it can produce, whereas steel manufacturers can produce very high quality steel because they can control the entire processing starting from ore.

A difficulty for large-batch steel producers is producing orders for small quantities as high-quality steel orders are typically high marginal-revenue but ask for small quantities. Production facilities cannot be re-tooled easily for smaller batch sizes without significantly large investments, and a policy of producing in units of the smallest batch size in reaction to customer orders will result in extra production that cannot be immediately sold, creating unplanned non revenue-generating inventory. On the other hand, batching received orders till they constitute a minimum batch size will result in long lead (or waiting) times for the orders.

Therefore, a need exists for a method for ore-based steel producers to manufacturer high-grade steel in small batches profitably. Further, a need exists for manufacturing small batch steel orders without significant capacity investments or wasted production, or extensive lead-times. Additionally, there is a need to determine how to prioritize different order types, and to choose a production system which is most efficient. Further needs include a method for determining optimal inventory policies for small batch high grade steel production that result in minimal disruption to the made-to-order products, minimal wastage and higher customer satisfaction.

### SUMMARY OF THE INVENTION

In an aspect of the invention, a method of managing manufacturing production includes determining a plurality of products for manufacture using a production line, each product including a product composition and production line steps; analyzing a plurality of production orders for the products; classifying each product as made-to-order (MTO) or made-to-stock (MTS); determining priority of the products in the production line; generating a stochastic characterization of demand for each product; determining preselected points along the production line for gathering an amount of inventory for a specified batch for at least one predetermined product; and establishing an inventory policy for each product at preselected points along the production line so that inventory is reviewed and an order is placed for additional inventory when on hand inventory reaches a predetermined reorder point.

In a related aspect, the method further includes: determining groups of products which use the made-to-order (MTO) process and the made-to-stock (MTS) process. In another aspect, the method further includes determining the optimal prioritization of the MTO products and the MTS products. The method may further include: determining, using analytics and optimization techniques, the preselected points for gathering inventory and the amount of inventory using expected demands of the products, product differentiability, expected revenue versus lead time and physical inventory storage constraints. The inventory policy may include evaluating batch production using subsititution rules that meet product criterias, wherein substitutable products of lower priority are used to complete batches of higher priority products. Further, the products may be steel products. The method may further include: determining inventory levels; and replenishing inventory of selected materials. Also, determining priority of the products may include determining lead-times for product delivery. The method may further include using a computer system including a computer program embodied on computer readable medium executable by a microprocessor in the computer system, and the computer program determines the priority of the products. Additionally, the method may further include providing a database in the computer system for storing stochastic models calculated using the computer system.

In another aspect of the invention, a computer program product comprises a computer readable medium having recorded thereon a computer program for enabling a processor in a computer system for managing manufacturing production. The computer program performs the steps of: determining a plurality of products for manufacture using a production line, each product including a product composition and production line steps; analyzing a plurality of production orders for the products and classifying them as MTO or MTS; determining priority of the products in the production line; generating a stochastic characterization of demand for each product; determining preselected points along the production line for gathering an amount of inventory for a specified batch for at least one predetermined product; and establishing an inventory policy for each product at preselected points along the production line so that inventory is reviewed and an order is placed for additional inventory when on hand inventory reaches a predetermined reorder point.

### BRIEF DESCRIPTION OF THE DRAWINGS

These and other objects, features and advantages of the present invention will become apparent from the following detailed description of illustrative embodiments thereof, which is to be read in connection with the accompanying drawings, in which:

FIG. 1 is a block diagram according to an embodiment of the invention depicting a method for managing a production system;

FIG. 2 is a block diagram of the relationship between production batches and orders;

FIG. 3 is a block diagram of a steel caster and priority determinations; and

FIG. 4 is a flow chart according to an embodiment of the invention of a method for managing production of steel products.

### DETAILED DESCRIPTION OF THE INVENTION

The method of the present invention uses a novel planning and production approach that allows made-to-stock (MTS) and made-to-order (MTO) for different product types on the same production facility to provide an optimized solution to the question of introducing small lot orders to steel producers' portfolios. The method considers multiple questions, including: which products should be made MTO and which MTS; how much inventory should be held on average; how should the various products be prioritized for service at the production facility; if the entire of production flow is considered (the multi-echelon production system), taking into account product-differentiation; and at which stages should MTS inventories be held; and how much inventory should be held on average.

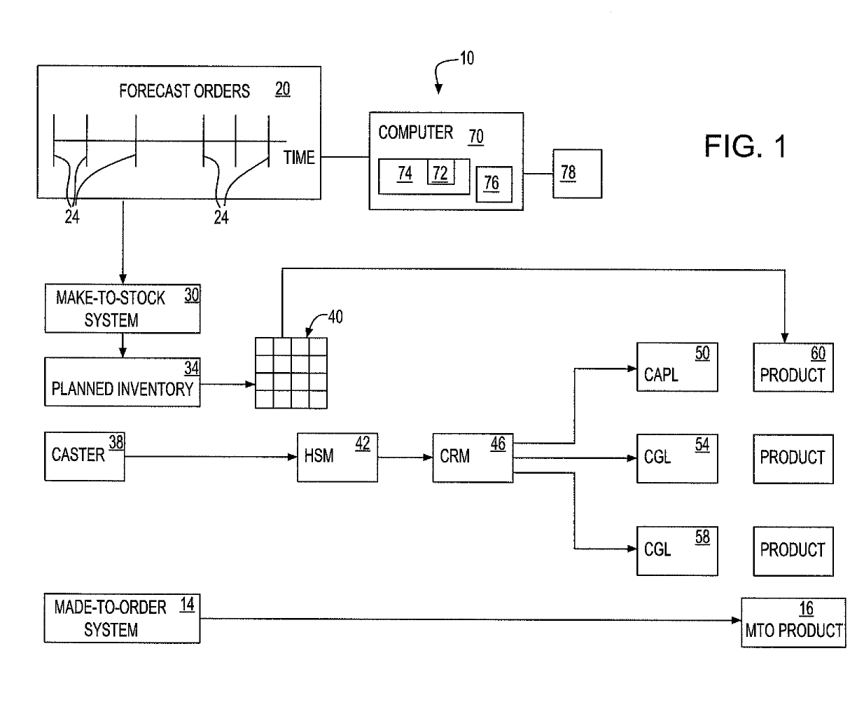

Referring to FIG. 1, an illustrative embodiment of a method of manufacturing production 10 according to the invention includes a strategic inventory system for orders of steel, but may be applied to any production system. In one part of the manufacturing production 10 shown in FIG. 1, steel orders are fulfilled using a made-to-order (MTO) system 14. In a MTO process 14 the production runs are triggered only after orders are received, and the order is pushed through the system to complete a MTO product 16. In an alternative production system, a made-to-stock (MTS) system 30, materials inventory 40 is held at strategic points in the production process, and different type orders are filled from the held inventory. Further, product inventory 60 is also held in the MTS system. The MTS system triggers inventory replenishment orders (pull orders) at specified times, which may be based on a review of inventory levels.

In operation, in the method of the present system, referring to FIG. 1, an order arrival process 20 is forecast. Planned inventory 34 is calculated from the forecast of the order arrival process. Inventory system parameters, e.g., size of replenishment orders, and replenishment trigger levels, are used to run a cost-efficient and optimized system. Inventory of multiple types such as the materials inventory 40 and the product inventory 60 may be held after any manufacturing stage such as shown in FIG. 1, after determining planned inventory 34 and after semi finished stages of production 38, 42, 46 in order to satisfy orders of multiple types. The types of orders are determined by differences in physical attributes (e.g., thickness, width) or chemical composition (e.g., grade).

In the embodiment of the invention shown in FIG. 1, the supply-chain to the MTS system is non-reentrant, i.e., the flow of WIP is in one direction, and product differentiation takes place further downstream. Alternative embodiments may include a bi-directional work flow. In the MTS system, end-products of the earlier stages can be used to fulfill orders for a wider range of product types, and this flexibility reduces as the production line approaches the final stages of production. Thus, inventory determinations are made using the MTS system considering that inventory held in earlier stages of production may be better utilized for multiple products, but holding more finished goods inventory can enhance fulfilling customer orders quickly.

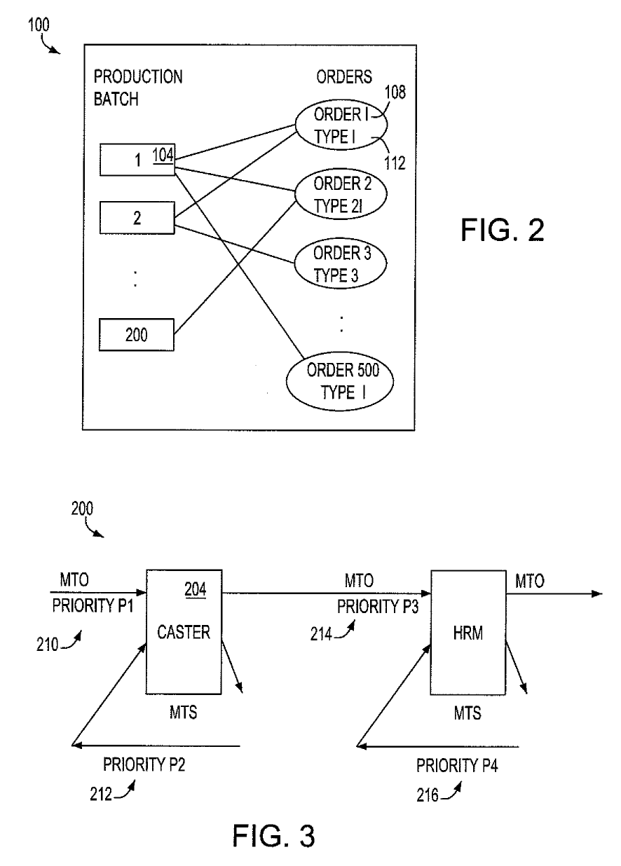

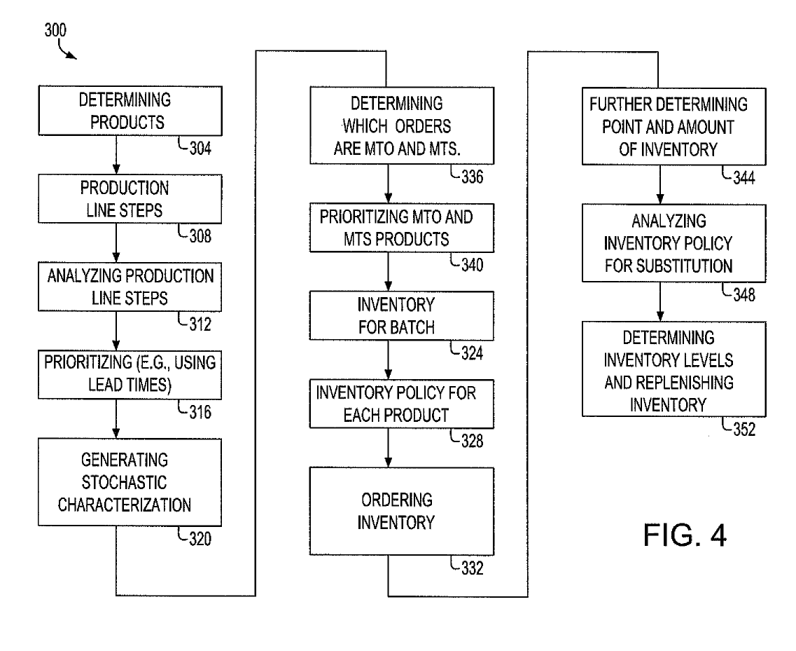

Additionally, referring to FIG. 2, in the method of the present invention, many of the manufacturing steps 100 are run in batches 104 which may be large, however, the batches 104 allow for substitutable products to be run together. Substitutability is different that the ability to differentiate the same upstream product further downstream, and can depend on the manufacturing stage. For example, at any stage in the manufacturing process, substitutable products differ from each other in certain characteristics but can be produced in the same production run using special capability designed into tools. Thus, orders 108 for steel of different types 112 can be cross referenced to varies batches 104. For instance, steel slabs of differing width (or thickness, or chemical composition) can be extruded from the same molten steel provided that the difference in the steel slabs is within an allowed range. Therefore, the method of the present invention includes a steel inventory management system that spans the entire lifecycle of the products and is optimized to take advantage of substitutability at each step in managing the inventory replenishment orders.

Thereby, the method of the present invention chooses which products should be fulfilled via the Made-to-Order system and which should be served from the Made-to-Stock system. The method sets up inventories at strategic locations in the (internal) supply-chain to fulfill retail-size orders. The location and average inventory levels are determined based on expected demands of these orders, product differentiability, expected revenue vis-à-vis lead time and any physical inventory storage constraints. Further, the method sets up an inventory replenishment ordering process. The MTS orders are processed with a goal to minimize disruption to (definite, revenue-generating) MTO orders, while also keeping the cost of servicing MTS orders low. Additionally, the method determines the priorities to be given to MTS replenishment orders and MTO orders at each manufacturing stage. This is to optimize the total cost of operating the plant to satisfy both types of demand. The method further adjusts the inventory levels and replenishment processes taking into account product substitutability at each step. Substitution can have a significant affect on the replenishment order sizes and hence the maintainable inventory levels.

The decision-making process in the various steps above are determined using algorithms constructed based on stochastic queuing network and stochastic bin-packing techniques, which is a novel and improved approach to solving the inventory problems of the present invention. A known method for managing production runs of small lot steel orders is disclosed in commonly owned U.S. Pat. No. 7,130,712, issued on Oct. 31, 2006, which is herein incorporated by reference in its entirety.

The parameters of the method of the present invention are chosen using algorithms that work at a microscopic level considering a single manufacturing stage at one time, and at a macroscopic level with multiple stages considered together. At the microscopic level, order types are assigned to the MTO or MTS system based on various criteria, for instance average order quantity, or order frequency. Optimized values for parameters controlling the inventory after a manufacturing stage are calculated. Referring to FIG. 3, a multiple stage production system 200 is shown including a steel caster 204. The caster 204 produces steel slabs in batches of a specified size for the MTO type of order or the MTS type of order. Inventory replenishment orders are placed when the inventory level is below a designated amount, and the order size Q is in multiples of the batch size. Each order type, MTO, MTS is given a priority number P1 210, P2 212, P3 214, P4 216 that dictates the order in which the orders are processed. The priority also determines what the replenishment level for inventory should be. Order replenishment considers substitutability, for example, if the entire batch is not needed by any order, then the remaining part of the batch can be devoted to producing inventory for orders of type with lesser priority. Mathematical models and rules are used to determine the suitability for joint-production in same batch. For example, different parameters and decisions are chosen based on modeling the single stage system as a stochastic queuing model with bin-packing constraints. The system is optimized to have the least long run cost. Additional manufacturing constraints such as limited inventory space may also be taken into account.

When considering multiple production stages, an additional layer of decision making is added, such as deciding where in the production stages should inventory be placed, and how much should be stored. Referring to FIG. 3, the two-stage production system includes one group of products being pushed through as an MTO while another is fulfilled as MTS, and the location and quantity of inventory to be held after the first and second stage are decided on. Inventory from stage two can be quickly used to fulfill MTS orders thus boosting customer satisfaction, but too much inventory might have to be held at that stage if one were to hold inventory for all MTS order types. On the other hand, inventory held at the first stage can be differentiated into multiple products in the second stage, and hence more inventory should be stored in the first stage, but this adversely affects customer satisfaction. According to the present invention, the supply chain life-cycle of the products is internal to the production system and thus the manufacturer can choose to carry inventory in strategically located points along the supply-chain to satisfy demand for certain retail-sized orders.

According to the present invention, queuing analytics and optimization techniques are used to provide the heuristics for determining inventory levels and order priority. For example, in a single production facility, stochastic bin packing algorithms may be used to investigate product prioritization questions. For alternative scenarios and assumptions, priority head-of-line queuing results may be used to express expected yield-loss and/or production lead time, which ultimately leads to simple optimization programs to choose the best prioritization rules and the MTS/MTO allocation. These analytical solutions and heuristics can be implemented in a software system and used by steel plant managers as a powerful planning tool when considering introduction of small lot orders in their product offerings.

Thus, in one embodiment of the invention a method of managing manufacturing production 300 includes determining a plurality of products to manufacture using a production line 304. Each product includes a product composition and production line steps 308. The method analyzes a plurality of production orders for the products 312. Further, the method determines the priority of the products in the production line 316. A stochastic characterization is generated modeling demand for each product 320. The method of the present invention may also include determining which products use a made-to-order (MTO) process and which products use a made-to-stock (MTS) process 336. The method may further include prioritizing the MTO products and the MTS products 340. Preselected points are determined along the production line for gathering an amount of inventory for a specified batch for at least one predetermined product 324. An inventory policy is established for each product at preselected points along the production line 328. Inventory is reviewed and an order is placed for additional inventory when on hand inventory reaches a predetermined reorder point 332. Additionally, the method may further include determining the preselected points for gathering inventory and the amount of inventory using expected demands of the products, product differentiability, expected revenue versus lead time and physical inventory storage constraints 344. The inventory policy may include evaluating materials and batches for meeting product criterias, and substituting batches when substitution is possible for another product and/or for a higher priority product 348. further, the method may be applied to steep products and steel production. The method may further include determining inventory levels, and replenishing inventory of selected materials 352. Further, determining priority of the products may include determining lead-times for product delivery in step 316. The method may further include using a computer system 70 including a computer program 72 embodied on computer readable medium 74 executable by a microprocessor 76 in the computer system 70, and the computer program 72 determines the priority of the products, as shown in FIG. 1. The method may further include a database 78 in the computer system 70 for storing stochastic models calculated using the computer system 70.

In an example of a queuing model a Head-of-the-Line priority queuing system is described. Different production orders often require different grades of steel, which are handled separately during manufacturing. Typically, orders that require higher grades of steel (special orders), usually require small sizes, and are of small frequency. However, the profit margins for these special orders are typically large. Therefore in practice these orders are often given higher priority. The problem can be modeled as a Head-of-the-Line priority queuing system. Assuming there are N types of orders, where order type N has the highest priority, order type N−1 has the second highest priority, and so on. Every type of order requires a different steel grade, so that orders have to be satisfied independently. Assuming each type i arrives according to a Poisson process with rate i, and each order requires a random weight ai with mean ¹ai. Each production run produces a charge B, and takes a fixed period of time xᵢ depending on the order type. The waiting time of the orders needs to be resolved. Canonical results from head-of-the-line queuing models can be applied here. The average waiting time for type p is:

$${W}_{p} = {W}_{o} + {\sum }_{i = p}^{N} {x}_{i} = {x}_{i} λ {W}_{i} + {\sum }_{i = p + 1}^{N} {x}_{i} {λ}_{i} {W}_{p}$$

Define σₚ=Σ^{N}ᵢ₌ₚpᵢ, then the solution can be solved recursively:

$${W}_{p} = \frac{{W}_{o}}{( 1 - {σ}_{p} ) ( 1 - {σ}_{p + 1} )}$$

where Wₒ is the average waiting time due to the job being processed,

$${W}_{o} = {\sum }_{i = 1}^{N} \frac{{λ}_{i} {x}^{2}}{2}$$

since xᵢ is deterministic. Therefore for order type p, the average waiting time is calculated.

Assuming the subset of order types S c {1; 2, . . . N} are served using inventory only. Inventories are managed with (Q, r) policy where Qᵢ=B for all i. Then the arrival rates for the replenishment orders can be calculated. The arrival process for the replenish orders is not Poisson anymore, but can be approximated as a Poisson process with new arrival rate λ_{I}, and the new waiting time for replenishment order p can be calculated.

Assuming a linear inventory holding cost h and a linear customer waiting cost w, then TC(p, r) is defined as the total average cost, if order types p, p+1, . . . , N are made to stock and the reorder points are r=(rp, rp+1, . . . , rN). Assuming that orders do not cross, the average backorder is E(Di−ri)+, and the average inventory is E(ri−Di)+, where Di is the total order requirement during lead time Wi. Therefore TC(p, ri)=hiE(ri−Di)++wi E(Di−ri)+. It is clear that waiting time of make-to-order products does not depend on r. For make-to-stock products, the average inventory and backorder can be computed. The function TC can be shown to be convex in r. The optimal ri is obtained by solving minTCi(p, ri).

A storage limit for inventory can be calculated for steel companies which often have limited storage room to hold inventory. Additionally, an example of determining priority rules is described wherein an initial assumption is made to treat all production orders as made to order. In this case, the following problem needs to be solved:

$${Min}_{P} {\sum }_{i = 1}^{N} {w}_{i} {W}_{i}$$

where P is the permutation of (1 . . . N). By swapping i and i+1, the costs for all the other order types 1 . . . i−1 and i+2 . . . N are not changed. So the total cost of i and i+1 are compared before and after swapping. The orders should be sorted according to a w/p rule, from high to low where p is the utilization. Very commonly, the production times for different types of steels are the same. It is assumed that waiting costs are the same, then different orders should be sorted by arrival rate, i.e., the most infrequent orders should get the highest priority.

When orders are made to stock, waiting costs are compared for actual orders. Again, given a priority ordering, if two adjacent orders are swapped i; i+1, then the other orders are not affected. Therefore, using a bubble sorting algorithm to determine the optimal sorting, including:

Step 1: Start with a priority rule. Solve optimal r_{N} and r_{N-1}, compute the costs, and then solve optimal r if swap order type N and N−1. Compare two total costs, if swapping is better, change the sorting;

Step 2: Repeat Step 1 with N−1 and N−2, and so on, until reaching 2 and 1; and

Step 3: Repeat the steps above until no adjacent orders can be swapped.

Note that the algorithm above does not work when there is a storage limit. In that case the costs can no longer be separated, and enumeration has to be performed.

An example of yield consideration includes assuming that make-to-order demands are not combined, that is, producing a whole charge for any single make-to-order demand. It is shown if the w=p rule would be changed in this case. A yield loss cost yᵢ for order type i is defined. Then on average, each make-to-order demand incurs a wastage cost yi(B−aᵢ). This costs are constant which is independent of the priority rules. Therefore in this case priority rules are not changed. If the assumption that orders are not combined is relaxed, the problem becomes much more complicated. The difficulty of the problem is that the number of orders combined in each batch is not constant, instead, it depends on the number of waiting orders in the system. For each batch, a random variable Y is defined to represent a yield, and to find the lower bound and upper bound for the yield distribution. The lower bound is when only one order is produced in each batch. Therefore yield is the amount of workload received during one production run x. If G(.) is the weight requirement distribution for each order, then the lower bound for yield distribution is a compound Poisson process truncated by casting capacity. The long-run queue length distribution can be obtained from canonical results of head-of-the-line queues for M/D/1 system.

An example of stochastic bin packing model includes an assuming storage constraints are not limited, and more precise average lead time and queue length for different orders can be obtained computationally. Everyday orders are received requiring different weight, width, and steel quality. To simplify the problem, an assumption is made that orders only differ in weight, capacity is fixed for each day, and orders are processed according to a certain priority rule. To model this problem as a stochastic bin packing problem, assuming that in each period t=1, 2, . . . , T, . . . :, there is a bin with size B. There are N types of orders n=1, 2, . . . N, each of them requires size S(n). The events happen in the following sequence. Unsatisfied orders form a queue of individual type. Each queue has a capacity C(n) which can be infinity. Order types with higher indices have a higher priority, so at the beginning of period t, and starting to fill the bin with type N orders. If the remaining space in the bin is not enough for a particular order, this order remains waiting in the queue. Once the maximum possible number of type N orders are filled, the bin leaves the system, and then new orders arrive and join the end of the queue of their own types. An A(n) number of type n orders may be received. A(n) follows a discrete probability distribution Prob(A(n)=1)=p^{l}ₙ, l=0, 1, . . . , L(n), where L(n) is the maximum possible arrivals in one period for type n, and arrivals of different periods and different types are independent. Then, a new period t+1 starts and the above process repeats.

To determine the average queue length and service level for each order type, the state Q(n, t) is defined as the queue length of type n order at the beginning of period t. A fit function fn(qn+1, . . . qN) is defined as the maximum number of type n orders that can fit in the bin given the queue lengths for type n+1, . . . , N are qn+1, . . . qN. Note that fn is independent of order type n, n−1, . . . , 1. For example, if bin size is 10, there are N=5 types of orders, and for each type n, order size S(n)=n, then the fit function f2(2, 0, 0)=2, since the bin needs to pack 2 type-3 orders, each of which requires 3 unit of room, and each type-2 order takes 2 unit of room. Similarly, f2(1, 1, 0)=1, and f2(3, 1, 1)=0. Clearly the process Q(n, t) is also independent of the process Q(m, t) for m<n. In the next period, some orders are packed in the bin and some new orders arrive, so the state transition between two periods is captured by a generated equation. Then well-known results can be applied to solve for the stationary queue length distribution. To solve matrix equations with large number of order types, applying an approximate method to solve for the stationary probability distribution and also to test stability using an algorithm. Using the algorithm a comparison between the approximation algorithm and solving πP=π directly to solve for a small number of types.

An example of data processing includes applying the algorithm described above, with some preparation to process the raw data. To obtain a reasonable number of order types, and obtain information to run the approximate algorithm, the following steps are taken to process the raw data:

1. Due dates are calculated as the difference between required due date (the last column) and the starting date (the second last column);

2. Since the due date above is the required time for the whole manufacturing process, and there is no information about the required time for charging process only, the due dates above are subtracted by 10 days, which is the reasonable time for other processes;

3. To make the number of order types a reasonable number, the weight-due date space by grids is partitioned. Each grid is of weight 20 and due date 3. The weight and due dates of all orders within one grid are changed into the same weight and due date. Then all orders are classified into 264 types, which differ by weight and due dates. FIG. 1 plots the modified weight and due date distribution for all orders;

4. Arrival probabilities and maximum arrivals are computed. Time unit is one day. For each type of orders, the arrival probability p^{j}ₙ is computed as the frequency that there are j orders of type n arriving in one day; and

5. After modifying due dates and weight, the new average load per day is 4639 tons, the bin size is assumed to be 4700, and the loading factor is 4639/4700=98.7%. For all orders, the queue capacities are assumed to be 250.

An example of rules for prioritizing is a best fit algorithm, where orders that require the largest size are packed first, and this has been shown to work well for scheduling policy in many situations. On the other hand, orders with shorter due date should get higher priority in order to receive an optimum service level. The following six priority rules balance these two attributes, where the last three are of the same type but having different parameters:

1. Weight First Rule: Orders requiring larger weight are processed first. For orders requiring the same weight, priority is given to orders that require shorter due date;

2. Due Date First Rule: Orders requiring shorter due date are processed first. For orders requiring the same due date, priority is given to orders that require larger weight;

3. Weight Due Date Ratio Rule: Define an index=weight/due date. Orders with higher indices are processed first; and

4. Weight Due Date Difference Rule: Define an index=weight/maximum weight−α* due date/maximum due date. Orders with higher indices are processed first. Different values for α are selected, including 0.5, 1, 1.5.

An example is discussed of determining performance measures and results by examining the effect of priority rules on average queue length, and service level. The following performance measures are examined:

avgf(n): at stationary state, maximum number of type n that a bin can fill; avgf(n) is computed in the algorithm;

average queue length of type n: this can be computed from a stationary queue length distribution;

Average sojourn time of type n: this is the average time that an order stays in the system, and can be computed by Little's Law: average queue (n)/average arrival(n);

Average queue load: since different types require different weight, the total average queue length is not directly comparable, thus the average load waiting in the queue is computed;

Approximate number of late orders: if the average sojourn time for one type of order is larger than the required due date, it is labeled as approximately late. The approximate number of late orders is the total arrivals of those orders that are approximately late at stationary state; and

approximate late load(n): is the total arriving load of those orders that are approximately late at stationary state.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The Figures of the present invention may illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the present invention has been particularly shown and described with respect to preferred embodiments thereof, it will be understood by those skilled in the art that changes in forms and details may be made without departing from the spirit and scope of the present application. It is therefore intended that the present invention not be limited to the exact forms and details described and illustrated herein, but falls within the scope of the appended claims.

What is claimed is:

1. A method of managing manufacturing production, comprising:
determining a plurality of products for manufacture using a production line, each product including a product composition and production line steps;
analyzing a plurality of production orders for the products;
classifying each product as made-to-order (MTO) or made-to-stock (MTS);
determining priority of the products in the production line;
generating a stochastic characterization of demand for each product;
determining preselected points along the production line for gathering an amount of inventory for a specified batch for at least one predetermined product; and
establishing an inventory policy for each product at preselected points along the production line so that inventory is reviewed and an order is placed for additional inventory when on hand inventory reaches a predetermined reorder point.

2. The method of claim 1, further including:
determining groups of products which use the made-to-order (MTO) process and the made-to-stock (MTS) process.

3. The method of claim 1, further including:
determining the optimal prioritization of the MTO products and the MTS products.

4. The method of claim 1, further including:
determining, using analytics and optimization techniques, the preselected points for gathering inventory and the amount of inventory using expected demands of the products, product differentiability, expected revenue versus lead time and physical inventory storage constraints.

5. The method of claim 1, wherein the inventory policy includes evaluating batch production using substitution rules that meet product criterias, wherein substitutable products of lower priority are used to complete batches of higher priority products.

6. The method of claim 1, wherein the products are steel products.

7. The method of claim 1, further including:
determining inventory levels; and
replenishing inventory of selected materials.

8. The method of claim 1, wherein determining priority of the products includes determining lead-times for product delivery.

9. The method of claim 1, further including:
using a computer system including a computer program embodied on computer readable medium executable by a microprocessor in the computer system, and the computer program determines the priority of the products.

10. The method of claim 9, further including:
storing stochastic models calculated using the computer system in a database.

11. A computer program product comprising a computer readable storage medium having recorded thereon a computer program for enabling a processor in a computer system for managing manufacturing production, the computer program performing the steps of:
determining a plurality of products for manufacture using a production line, each product including a product composition and production line steps;
analyzing a plurality of production orders for the products and classifying them as MTO or MTS;
determining priority of the products in the production line;
generating a stochastic characterization of demand for each product;
determining preselected points along the production line for gathering an amount of inventory for a specified batch for at least one predetermined product; and
establishing an inventory policy for each product at preselected points along the production line so that inventory is reviewed and an order is placed for additional inventory when on hand inventory reaches a predetermined reorder point.

12. The computer program product of claim 11, further including:
determining groups of products which use the made-to-order (MTO) process and the made-to-stock (MTS) process.

13. The computer program product of claim 11, further including:
determining the optimal prioritization of the MTO products and the MTS products.

14. The computer program product of claim 11, further including:
determining, using analytics and optimization techniques, the preselected points for gathering inventory and the amount of inventory using expected demands of the products, product differentiability, expected revenue versus lead time and physical inventory storage constraints.

15. The computer program product of claim 11, wherein the inventory policy includes evaluating batch production using substitution rules that meet product criterias, wherein substitutable products of lower priority are used to complete batches of higher priority products.

16. The computer program product of claim 11, further including:
determining inventory levels; and
replenishing inventory of selected materials.

17. The computer program product of claim 11, wherein determining priority of the products includes determining lead-times for product delivery.

18. The computer program product of claim 11, further including:
storing stochastic models calculated using the computer system in a database.
